(19) United States
(12) Patent Application Publication
(10) Pub. No.: US 2016/0200589 A1
(43) Pub. Date: Jul. 14, 2016

(54) METHOD FOR MAKING LITHIUM COBALT OXIDE

(71) Applicants: Jiangsu Huadong Institute of Li-ion Battery Co. Ltd., Zhangjiagang (CN); Tsinghua University, Beijing (CN)

(72) Inventors: MOU FANG, Beijing (CN); YAO-WU WANG, Beijing (CN); XIANG-MING HE, Beijing (CN); LI WANG, Beijing (CN); YU-MING SHANG, Beijing (CN); JIAN GAO, Beijing (CN); JIAN-WEI GUO, Beijing (CN); ZONG-QIANG MAO, Beijing (CN)

(21) Appl. No.: 15/053,261

(22) Filed: Feb. 25, 2016

Related U.S. Application Data
(63) Continuation of application No. PCT/CN2014/084280, filed on Aug. 13, 2014.

(30) Foreign Application Priority Data
Aug. 27, 2013 (CN) 201310378779.6

(51) Int. Cl. C01G 51/00; H01M 10/0525; H01M 4/131; H01M 4/525

(52) U.S. Cl. CPC C01G 51/42; H01M 4/525; H01M 10/0525; H01M 4/131; C01P 2006/40; H01M 2220/30

(57) ABSTRACT

A method for making lithium cobalt oxide requires a cobalt salt solution and an alkaline solution as reactants, these reactants being put into a controlled crystallization reactor containing a buffer agent. The reactants are stirred to form spheres of cobalt oxyhydroxide. The spherical cobalt oxyhydroxide is put into a lithium hydroxide solution to have a hydrothermal reaction in a hydrothermal reactor to replace the hydrogen in cobalt oxyhydroxide with the lithium in lithium hydroxide, to form a product of spheres.

### CROSS-REFERENCE TO RELATED APPLICATIONS

This application claims all benefits accruing under 35 U.S.C. §119 from China Patent Applications No. 201310378779.6, filed on Aug. 27, 2013 in the China Intellectual Property Office, the content of which is hereby incorporated by reference. This application is a continuation under 35 U.S.C. §120 of international patent application PCT/CN2014/084280 filed Aug. 13, 2014, the content of which is hereby incorporated by reference. This application is related to a commonly-assigned application entitled, “METHOD FOR MAKING SPHERICAL COBALT OXYHYDROXIDE”, filed ______ (Atty. Docket No. US59408).

### FIELD

The present disclosure belongs to lithium ion batteries, and specifically relates to a method for making lithium cobalt oxide.

### BACKGROUND

Smart phones, tablets, laptops, and mobile tools are based on development of lithium ion rechargeable batteries. Small portable electronic devices have critical demands on the batteries for safety, thermal stability, cycling life, etc. For this reason, lithium cobalt oxide is irreplaceable as a cathode active material in the lithium ion battery at present and in a foreseeable future.

A conventional method for making the lithium cobalt oxide is a solid phase method in which cobalt oxyhydroxide as a precursor is previously formed and then sintered at a high temperature to form cobalt (II,III) oxide (Co₃O₄). The Co₃O₄ is then mixed with lithium carbonate and sintered again to render a product, which the needs a ball-milling procedure.

### BRIEF DESCRIPTION OF THE DRAWINGS

Implementations are described by way of example only with reference to the attached figures.

FIG. 1 is a flowchart of an embodiment of a method for making lithium cobalt oxide.

FIG. 2 is a schematic view of an embodiment of a controlled crystallization reactor used in the method for making the lithium cobalt oxide.

FIG. 3 shows a scanning electron microscope (SEM) image of an embodiment of lithium cobalt oxide.

FIG. 4 shows a X-ray diffraction (XRD) pattern of the embodiment of lithium cobalt oxide.

FIG. 5 shows electrochemical performance of an embodiment of a lithium ion battery using the lithium cobalt oxide made in accordance herewith.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

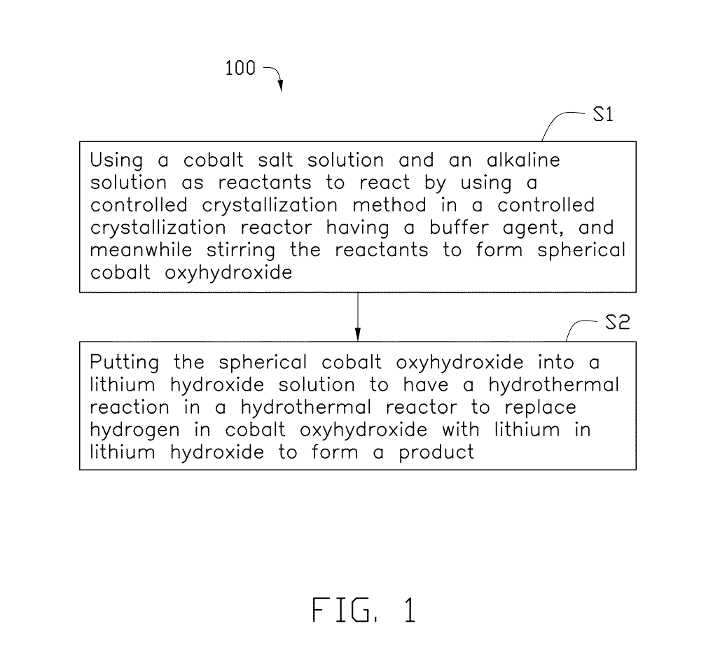

FIG. 1 presents a flowchart of an exemplary method. This embodiment of a method 100 for making lithium cobalt oxide is provided by way of example, as there are a variety of ways to carry out the method 100. Each block shown in FIG. 1 represents one or more processes, methods, or subroutines carried out in the exemplary method 100. Additionally, the illustrated order of blocks is by example only and the order of the blocks can be changed. The exemplary method 100 can begin at block S11. Depending on the embodiment, additional steps can be added, others removed, and the ordering of the steps can be changed.

At block S1, a cobalt salt solution and an alkaline solution are used as the reactants. The reactants react according to a controlled crystallization method in a controlled crystallization reactor having a buffer agent, and meanwhile the reactants are stirred to form spherical cobalt oxyhydroxide.

At block S2, the spherical cobalt oxyhydroxide is put into a lithium hydroxide solution to undergo a hydrothermal reaction, in which the lithium in the lithium hydroxide replaces the hydrogen in the cobalt oxyhydroxide, to form spherical lithium cobalt oxide.

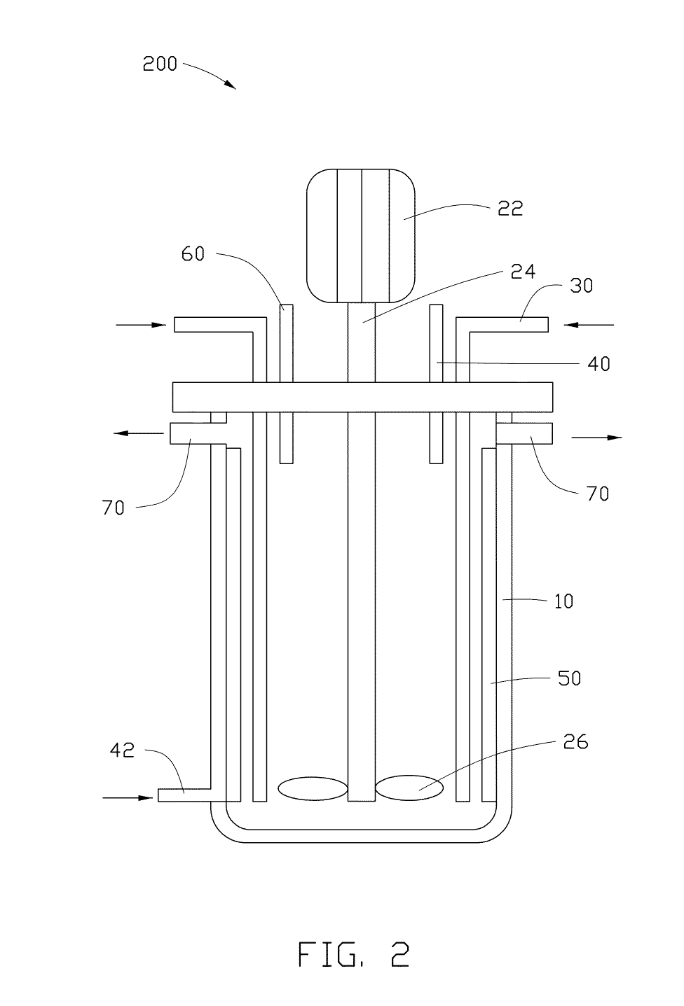

Referring to FIG. 2, the controlled crystallization reactor 100 comprises a container 10, an agitating device 20, and a feeding device.

The agitating device 20 is capable of agitating the reactants that are contained in the container 10. The agitating device comprises a motor 22, a shaft 24, and a paddle 26. The shaft 24 is connected to the motor 22. The paddle 26 is mounted on the shaft 24. In one embodiment, the paddle 26 is mounted only on an end of the shaft 24. The motor 22 is capable of driving the shaft 24 to rotate, and the rotating of the shaft 24 drives the paddle 26 to rotate. The end of the shaft 24 that has the paddle 26 mounted thereon is inserted in the container 10, and reaches a bottom region of the container 10. Thus, the paddle 26 only stirs at the bottom region in the container 10. Accordingly, the materials in the container 10 are agitated only at the bottom region of the container 10, and the non-uniform agitation of the materials in the container 10 leads to a non-uniform reaction. The agitating device 20 can comprise one or more paddles 26. The quantity of the paddles 26 can be decided according to a depth of the container 10. When the container 10 is relatively shallow, only one pair of paddles 26 can be set only at the end of the shaft 24. When the container 10 is relatively deep, a plurality of pairs of paddles 26 spaced from each other can be set at the end of the shaft 24. However, the paddles 26 are always located only at a bottom region in the container 10. In one embodiment, the bottom region can be defined from the surface of inner bottom of the container 10 to a level having 1/10˜⅓ depth of the container 10. By locating all paddles 26 in the bottom region, non-uniform agitation takes place in the container 10.

The feeding device can comprise a plurality of inlet tubes 30, by which the different reactants and buffer agent are respectively fed into the container 10. For example, the feeding device can comprise a cobalt salt solution inlet tube, an alkaline solution inlet tube, and a buffer agent inlet tube.

The controlled crystallization reactor 100 can further comprise a temperature controlling device to provide a controllable temperature in the container 10. The temperature controlling device can comprise a heater and a thermometer 40. The heater can be disposed on an outer surface of a sidewall of the container 10. For example, the heater can be a water bath 42 as shown in FIG. 2 or comprise resistance wires. The thermometer 40 can be inserted in the reactants in the container 10 to monitor the reacting temperature of the reactants in the container 10.

The controlled crystallization reactor 100 can further comprise a baffle plate 50 located on an inner surface of the side wall of the container 10. The baffle plate 50 promotes the mixing of the reactants by blocking the materials during the agitating.

The controlled crystallization reactor 100 can further comprise a pH meter 60 to monitor the pH value in the container, thereby enabling control of the amount of the reactants.

The controlled crystallization reactor 100 can further comprise an overflow outlet 70 located at an upper side of the side wall of the container 10. The materials that reach the overflow outlet 70 during the agitating escape the container 10.

At block S1, the reactants can be non-uniformly agitated in the controlled crystallization reactor 100. More specifically, the reactants can be stirred only at the bottom region of the container 10. In one embodiment, the reactants are agitated only in a region up from the inner bottom of the container 10 to a level having 1/10˜⅓ depth of the container 10, and the level is measured from the inner bottom. A degree of filling up with the reactants in the container 10 can exceed the agitating region. In one embodiment, the reactants fill the container 10 up to more than ½ its depth. In another embodiment, the reactants fully fill the container 10 and reach the overflow outlet 70. During the agitating, any excess of reactants is expelled from the container 10 through the overflow outlet 70.

During the stirring of the reactants by the paddles 26 only in the bottom region of the container 10, the reacting product, i.e., the cobalt oxyhydroxide, in particle form, continuously collide with each other to form cobalt oxyhydroxide solid spheres having a regular spherical shape. Since the stirring of the paddles 26 only takes place in the bottom region in the container 10, the materials that are stirred have a tendency to rise up due to the centrifugal force formed by the rotating of the paddles 26, a rapid growth of the cobalt oxyhydroxide spheres caused by stirring at every region in the container 10 can be avoided, and the cobalt oxyhydroxide spheres move up and down repeatedly in the container 10 during the stirring, which results in greater forces in the collisions, to form dense and then denser spherical solid spheres made of the cobalt oxyhydroxide. When the formed spheres of cobalt oxyhydroxide have a sufficient diameter, they are thrown out from the container 10 through the overflow outlet 70, which ends the growing of the diameter. Thereby, the diameter of the spherical cobalt oxyhydroxide can be controlled.

A concentration of the buffer agent and a rotating speed of the paddles 26 can be controlled to control the reacting speed, by which regular cobalt oxyhydroxide solid spheres having a dense structure and a with controlled diameter can be formed during the non-uniform agitation.

The rotating speed of the paddles 26 can be in a range from 900 revolutions per minute (rpm) to 2000 rpm, which results a violent rotation. The concentration of the buffer agent in the controlled crystallization reactor 100 can be in a range from 3 mol/L to 8 mol/L. A diameter of the spherical cobalt oxyhydroxide can be in a range from 5 μm to 20 μm.

If the paddles 26 are uniformly located at every level of the container 10, a uniform agitation can take place in the container 10, during which the forces applied to the materials in the container 10 is weaker than those during non-uniform agitation. A test result shows that uniform agitation creates a majority of hollow spheres with diameters that are unable to be controlled. That is, the spheres grow to relatively large diameters, whereas the inside of the sphere is still loose and non-solid.

At block S1, the reactants of the controlled crystallization reactor 100 can be further heated during the non-uniform agitation to have a reacting temperature in a range from 40° C. to 60° C.

At block S1, the cobalt salt solution can be a water solution of a soluble cobalt salt. The cobalt salt can be selected from at least one of cobalt chloride, cobalt sulfate, and cobalt nitrate. The alkaline solution can be a strong alkaline solution, such as a water solution of potassium hydroxide, a water solution of sodium hydroxide, or a mixture thereof. In the controlled crystallization reactor 100, a molar ratio between the cobalt salt and the sodium hydroxide is about 12. The buffer agent can be selected from at least one of ammonium hydroxide, ethylenediamine tetraacetic acid (EDTA), and lactic acid. The buffer agent is added for controlling the reacting speed of the reactants.

At block S1, the method can further comprise steps of:

preloading the buffer agent into the controlled crystallization reactor 100;

then adding the cobalt salt solution and the strong alkaline solution simultaneously through their own respective inlet tubes 30 into the buffer agent in the controlled crystallization reactor 100; and

non-uniformly stirring the reactants in the controlled crystallization reactor 100.

At block S1, the method for making the spherical cobalt oxyhydroxide is a continuous process, wherein after the buffer agent is put into the controlled crystallization reactor 100, the cobalt salt solution and the alkaline solution are continuously added into the controlled crystallization reactor 100. The adding of the cobalt salt solution and the alkaline solution and the non-uniform agitating of the reactants in the controlled crystallization reactor 100 are continuously processed. By controlling the feeding speed of the cobalt salt solution and the alkaline solution, and by controlling the rotating speed of the paddles 26, the formed spherical cobalt oxyhydroxide continuously overflows through the overflow outlet, and the amount of the reactants in the controlled crystallization reactor 100 is maintained, thereby continuously forming the spherical cobalt oxyhydroxide. The feeding amount per minutes of the reactants can be in a range from 1/10000 to 1/300 of the volume of the container 10.

The cobalt salt solution and the alkaline solution can be fed slowly into the container 10 through two inlet tubes 30 by using peristaltic pumps. By controlling the feeding speed of the cobalt salt solution and the alkaline solution, the molar ratio between the cobalt salt and the sodium hydroxide is controlled to be about 1:2 in the container 10. The pH value of the reactants in the container 10 is monitored. From the adding of the reactants to the overflowing of the spherical cobalt oxyhydroxide that is formed from the exact reactants, the materials remain for 5 hours to 72 hours in the container 10.

At block S1, the spherical cobalt oxyhydroxide which has overflowed from the controlled crystallization reactor 100 can be washed by deionized water.

At block S2, the spherical cobalt oxyhydroxide can be mixed with the lithium hydroxide solution to have a hydrothermal reaction. More specifically, the obtained spherical cobalt oxyhydroxide and lithium hydroxide solution can be mixed and filled into a hydrothermal reactor to have a hydrothermal reaction.

A concentration of the lithium hydroxide solution is not limited. In one embodiment, a saturated lithium hydroxide solution is used. In the hydrothermal reactor, a molar ratio between the cobalt oxyhydroxide and the lithium hydroxide can be smaller than 11. A reacting temperature of the hydrothermal reaction can be in a range from 150° C. to 200° C. A reacting time of the hydrothermal reaction can be 1 hour to 5 hours. A pressure in the hydrothermal reactor is self-generated, caused by the heating, can be about 15 atms to about 22 atms, and preferably be 18 atms. The hydrothermal reaction replaces the hydrogen in the spherical cobalt oxyhydroxide with the lithium in the lithium hydroxide, during which the spherical shape of the cobalt oxyhydroxide is maintained, to form spherical lithium cobalt oxide. Additionally, after the hydrothermal reaction, the residual lithium hydroxide solution can be recycled.

After block S2, the spherical lithium cobalt oxide formed by the hydrothermal reaction can be pumped and dried, for example, vacuum dried at 50° C. to 90° C. for 5 hours to 10 hours.

The method for making the spherical lithium cobalt oxide can further comprise a step S3 of sintering the obtained lithium cobalt oxide. The lithium cobalt oxide can be sintered in an oven at a temperature of 350° C. to 800° C. for 3 hours to 10 hours. The sintering step is to remove the water of crystallization or other impurities in the product of the hydrothermal reaction, and to increase the crystallinity of the lithium cobalt oxide. The sintering step can take place in the open air.

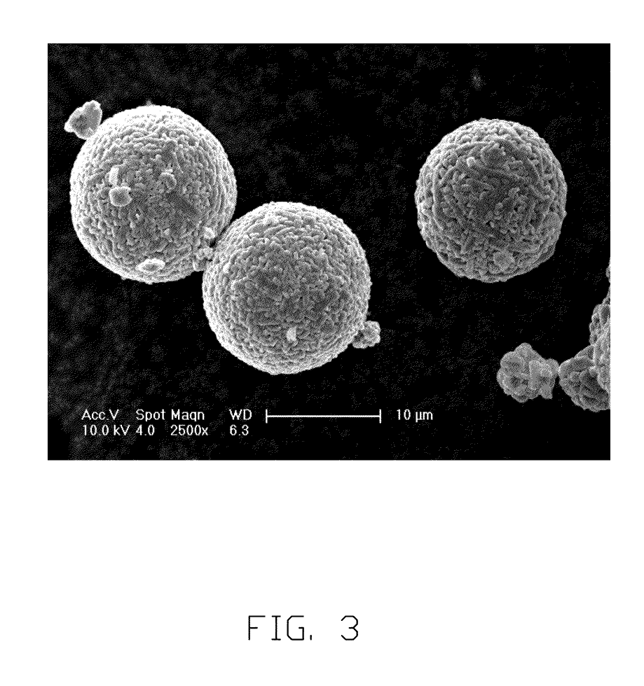

Referring to FIG. 3, the cobalt oxyhydroxide formed by the present method is in a spherical shape. The spherical cobalt oxyhydroxide has a one-step formation process, initial powders of cobalt oxyhydroxide do not need to be formed as a preliminary, and neither do secondary balls need to built by aggregating the initial powders through processes such as prilling and riddling. The spherical cobalt oxyhydroxide obtained from the present method has a dense structure, an ordered shape, and a high tap density. Therefore, the lithium cobalt oxide formed from the spherical cobalt oxyhydroxide also has a spherical shape, a dense structure, an ordered shape, and a high tap density.

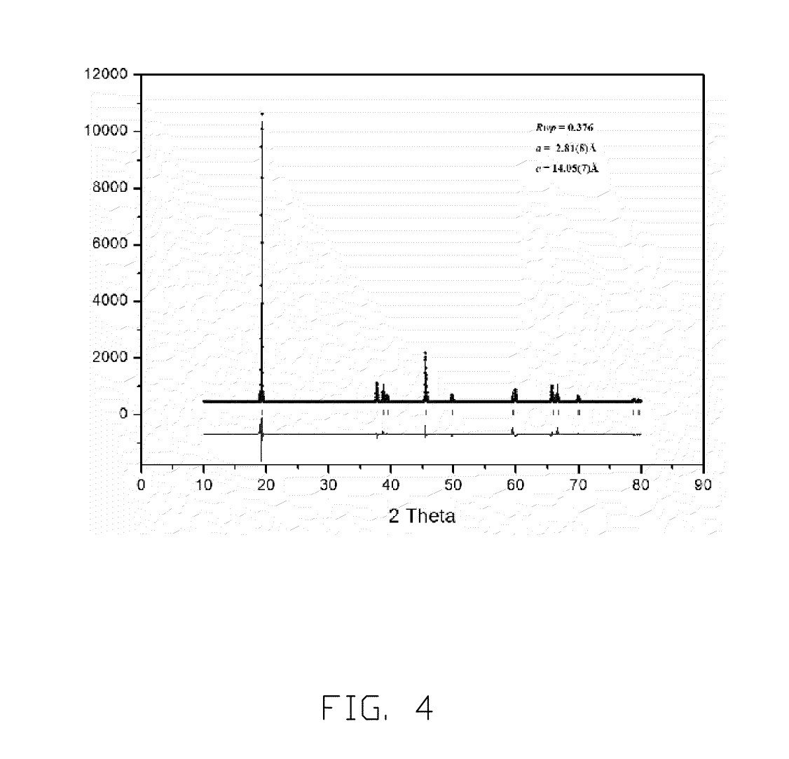

Referring to FIG. 4, an XRD test is applied to the spherical lithium cobalt oxide. 2 Theta in FIG. 4 represents the scanning degree, a and c are lattice parameters. By comparing with the standard pattern of lithium cobalt oxide as shown at bottom of the FIG. 4, the XRD pattern of the product can be identified as lithium cobalt oxide showing no impurity peaks, and which has a relatively high peak strength indicating that the obtained lithium cobalt oxide has a relatively high crystallinity.

The present method uses a hydrothermal reaction to form the lithium cobalt oxide, having the entire synthesis take place in the liquid phase, by which the materials can be uniformly mixed at a low energy consumption, and the reacting solution can be recycled. The formed lithium cobalt oxide has the morphology of regular spheres. The spheres are obtained during the synthesis of the cobalt oxyhydroxide, and this morphology is maintained in all the following steps. The spheres have a controllable diameter and a high tap density. The spherical lithium cobalt oxide can have a diameter in a range from 5 μm to 20 μm, and a tap density in a range from 2.3 g•cm⁻³ to 2.9 g•cm⁻³.

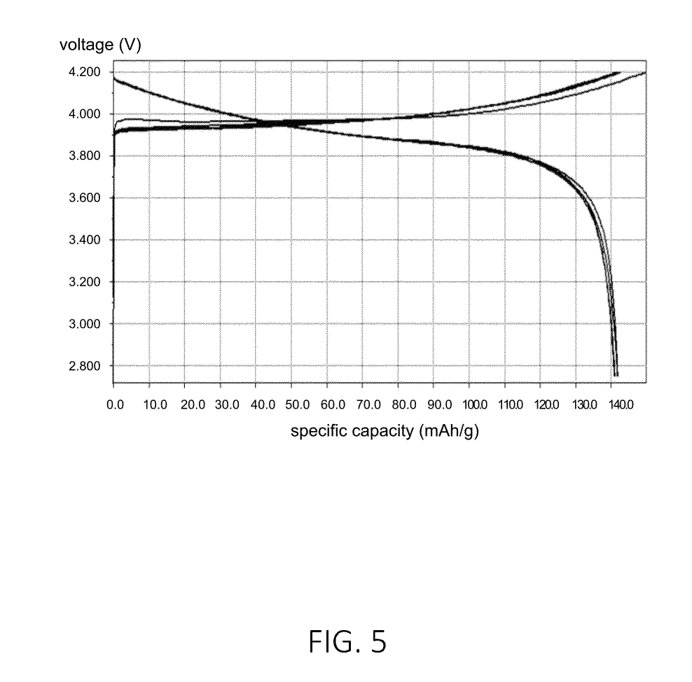

Referring to FIG. 5, a lithium ion battery is assembled by using the obtained spherical lithium cobalt oxide as the cathode active material and lithium metal as the anode. The lithium ion battery is cycled and shows that the specific capacity is about 140 mAh/g with no significant decrease during the first 100 cycles. The spherical lithium cobalt oxide has a relatively high loose packed density and tap density, and a relatively small specific surface area. A surface modification to the micro-sized spheres can be more effective than that applied to nano-sized powder. Accordingly, a uniform, stable, dense, and firm surface coating on the spherical lithium cobalt oxide can be obtained. Further, the micro-sized spheres of lithium cobalt oxide have a relatively good dispersing ability and mobility, which are beneficial for making the electrode plate of the lithium ion battery.

### EXAMPLE 1

1) A controlled crystallization reactor having a volume of 4 L is used. 4 mol/L of ammonium hydroxide solution as the buffer agent is added into the controlled crystallization reactor, and mechanically stirred fast with a speed of 1500 rpm. 2 mol/L of cobalt chloride water solution and 4 mol/L of sodium hydroxide water solution are slowly added from two sides using the peristaltic pumps, with a flow rate of 0.5 mL/min, to form the spherical cobalt oxyhydroxide.

2) The spherical cobalt oxyhydroxide formed by 1) is washed several times by deionized water and pumped dry to remove the water.

3) 1 kg of spherical cobalt oxyhydroxide obtained by 2) is mixed with 400 g of saturated lithium hydroxide water solution and the mixture loaded into a high pressure hydrothermal reactor for the hydrothermal reaction. The hydrothermal reactor is heated to 150° C. and maintained for 5 hours at this temperature to obtain the spherical lithium cobalt oxide.

4) The spherical lithium cobalt oxide formed by 3) is taken out from the hydrothermal reactor and pumped dry.

5) The spherical lithium cobalt oxide obtained by 4) is dried at 50° C. for 10 hours.

6) The spherical lithium cobalt oxide obtained by 5) is introduced into the sintering oven and sintered at 800° C. for 5 hours. The cathode active material of the lithium ion battery is thus formed.

### EXAMPLE 2

1) A controlled crystallization reactor having a volume of 10 L is used. 8 mol/L of ammonium hydroxide solution as the buffer agent is added into the controlled crystallization reactor, and mechanically stirred fast with a speed of 900 rpm. 3 mol/L of cobalt chloride water solution and 6 mol/L of sodium hydroxide water solution are slowly added from two sides using the peristaltic pumps, with the flow rate of 2 mL/min, to form the spherical cobalt oxyhydroxide.

2) The spherical cobalt oxyhydroxide formed by 1) is washed several times by deionized water and pumped dry.

3) 3 kg of spherical cobalt oxyhydroxide obtained by 2) is mixed with 1 kg of saturated lithium hydroxide water solution and the mixture loaded into a high pressure hydrothermal reactor for the hydrothermal reaction. The hydrothermal reactor is heated to 200° C. and maintained for 1 hour at this temperature to obtain the spherical lithium cobalt oxide.

4) The spherical lithium cobalt oxide formed by 3) is taken out from the hydrothermal reactor is pumped dry.

5) The spherical lithium cobalt oxide obtained by 4) is dried at 90° C. for 5 hours.

6) The spherical lithium cobalt oxide obtained by 5) is introduced into the sintering oven and sintered at 350° C. for 10 hours. The cathode active material of the lithium ion battery is thus formed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making lithium cobalt oxide comprising:
reacting a cobalt salt solution and an alkaline solution by using a controlled crystallization method in a controlled crystallization reactor having a buffer agent while stirring a mixture of the cobalt salt solution, the alkaline solution, and the buffer agent to form spherical cobalt oxyhydroxide, the controlled crystallization reactor comprises a container containing the mixture; and
putting the spherical cobalt oxyhydroxide into a lithium hydroxide solution resulting in a hydrothermal reaction in a hydrothermal reactor to replace hydrogen in cobalt oxyhydroxide with lithium in lithium hydroxide to form a product.

2. The method of claim 1, wherein in the reacting the cobalt salt solution and the alkaline solution, the stirring the mixture is non-uniform stirring the mixture.

3. The method of claim 2, wherein the non-uniform stirring is stirring only at a region defined from inner bottom of the container to a place having 1/10 to ⅓ depth of the container.

4. The method of claim 1, wherein the controlled crystallization reactor further comprises an agitating device and a feeding device.

5. The method of claim 4, wherein the feeding device comprises a plurality of inlet tubes, and the reacting the cobalt salt solution and the alkaline solution by using the controlled crystallization method in the controlled crystallization reactor comprises feeding the cobalt salt solution and the alkaline solution to the container through respective inlet tubes.

6. The method of claim 4, the agitating device comprises a motor, a shaft, and at least one paddle; the shaft is connected to the motor, the at least one paddle is mounted only on an end of the shaft, and the end of the shaft that has the at least one paddle mounted thereon is located in a bottom region in the container.

7. The method of claim 6, wherein the at least one paddle is located only in the bottom region in the container.

8. The method of claim 6, wherein the reacting the cobalt salt solution and the alkaline solution by using the controlled crystallization method in the controlled crystallization reactor comprises rotating the at least one paddle, and a rotating speed of the at least one paddle is in a range from 900 rpm to 2000 rpm.

9. The method of claim 1, wherein the cobalt salt solution is a water solution of a soluble cobalt salt, and the soluble cobalt salt is selected from the group consisting of cobalt chloride, cobalt sulfate, cobalt nitrate, and combinations thereof.

10. The method of claim 1, wherein the alkaline solution is selected from the group consisting of a water solution of potassium hydroxide, a water solution of sodium hydroxide, and a combination thereof.

11. The method of claim 1, wherein a molar ratio between cobalt salt and sodium hydroxide is about 12.

12. The method of claim 1, wherein the reacting the cobalt salt solution and the alkaline solution by using the controlled crystallization method in the controlled crystallization reactor comprises feeding the cobalt salt solution and the alkaline solution to the container, and a feeding amount per minutes of the cobalt salt solution and the alkaline solution is in a range from 1/10000 to 1/300 of a volume of the container.

13. The method of claim 1, wherein the buffer agent is selected from the group consisting of ammonium hydroxide, ethylenediamine tetraacetic acid, lactic acid, and combinations thereof.

14. The method of claim 1, wherein the controlled crystallization reactor further comprises an overflow outlet located at an upper side of the container, when the spherical cobalt oxyhydroxide has an enough size of diameter, it is thrown out the container from the overflow outlet, which ends the growing of the diameter.

15. The method of claim 14, wherein a diameter of the spherical cobalt oxyhydroxide is in a range from 5 μm to 20 μm.

16. The method of claim 14, wherein the reacting the cobalt salt solution and the alkaline solution by using the controlled crystallization method in the controlled crystallization reactor comprises continuously feeding the cobalt salt solution and the alkaline solution and continuously agitating the mixture in the controlled crystallization reactor at the same time.

17. The method of claim 1, wherein a reacting temperature of the hydrothermal reaction is in a range from 150° C. to 200° C.

18. The method of claim 1 further comprises sintering the product at a temperature of 350° C. to 800° C.
